(19) United States
(12) Patent Application Publication
(10) Pub. No.: US 2018/0235734 A1
(43) Pub. Date: Aug. 23, 2018

(54) COPING SYSTEM WITH SNAP-IN RETENTION CAPABILITY

(71) Applicant: EVOLLUTION IP HOLDINGS, INC., Birmingham, AL (US)

(72) Inventors: Haibo FAN, Woodbridge, CT (US); Boris SIMMONDS, Vestavia, AL (US); Fred J MOLZ, IV, Birmingham, AL (US); John J. BELLANCA, Birmingham, AL (US)

(73) Assignee: EVOLLUTION IP HOLDINGS, INC., Birmingham, AL (US)

(21) Appl. No.: 15/957,481

(22) Filed: Apr. 19, 2018

Related U.S. Application Data
(63) Continuation-in-part of application No. 15/363,183, filed on Nov. 29, 2016.
(60) Provisional application No. 62/261,613, filed on Dec. 1, 2015.

(51) Int. Cl. A61C 8/00

(52) U.S. Cl. CPC A61C 8/0001; A61C 8/0045; A61C 8/0074; A61C 2201/002; A61C 8/0062; A61C 8/0012; A61C 2201/005; A61C 8/006

(57) ABSTRACT

A coping for intraoral scanning or impression molding that includes a snap-in retention capability for engagement with a dental implant having a first engagement section. The second engagement section is configured for a snap-in or frictional fit with the first engagement section to releasably secure the coping to the implant.

### CROSS-REFERENCE TO RELATED APPLICATIONS

This application is a continuation-in-part of U.S. Non-Provisional patent application Ser. No. 15/363,183 filed Nov. 29, 2016, which claims the benefit of U.S. Provisional Patent Application Ser. No. 62/261,613 filed Dec. 1, 2015, the entirety of which is hereby incorporated by reference herein.

### TECHNICAL FIELD

The present invention relates generally to the field of dental implants and prosthetics, and more particularly to a dental coping having snap-in retention and multi-functional capability for use with a dental implant or implant analog.

### BACKGROUND

Scan bodies or copings are typically used in the dental industry in conjunction with dental implants to create a digital restorative pathway (for example via intraoral scanning or desktop scanning) to determine the size, shape and orientation of a final restoration or prosthesis to be fitted on the implant. In most cases, scan bodies or copings are generally fastened to the implant with an abutment screw, which generally requires a clinician to manually screw the abutment screw to the implant. One drawback to manually screwing an abutment screw within the implant to fasten the coping to the implant is that some installation drivers can be long, requiring a significant amount of vertical space, thereby making placement of the abutment screw difficult in the posterior of a patient's mouth where vertical space is often limited. Another drawback is due to the time required to manually place and remove the abutment screw to/from the implant before and after scanning the coping. And the abutment screw can be dropped in the patient's mouth before placement or after removal; this may present an aspiration risk. Further, a coping that is screwed into the implant is difficult to use in impressions that are designed to pick up the coping, like a hybrid closed tray pick-up impression technique.

However, in some instances a clinician may use an impression or scanning technique that requires the coping to remain attached to the implant, like a traditional closed tray impression, also known as a transfer impression. A screw-in coping is also beneficial in desktop scanning techniques in which clinicians use a scan body indefinitely. A scan body that is screwed into the implant analog is not limited by wearing on the snap feature. Further, coping used in triple tray impressions must have a limited occlusal height to accommodate the impression tray. With known copings, a clinician would need different copings for impression and scanning techniques that require the coping to remain attached to the implant that those that require the coping to be quickly or easily removed from the implant. Clinicians generally have still another, shorter coping design for use with triple tray impressions. Therefore, clinicians are required to purchase additional, unneeded hardware and cannot be flexible in their choice of modeling techniques.

Accordingly, it can be seen that needs exist for an improved coping for use with dental implant procedures that can be both snap-fitted and fastened to a dental implant such that the coping can be used as an intraoral scan body, laboratory scan body, closed tray pick-up impression coping, open tray pick-up impression coping, and triple tray impression coping. It is to the provision of an improved coping meeting these and other needs that the present invention is primarily directed.

### SUMMARY

In example embodiments, the present invention provides a coping for intraoral scanning or impression molding that includes a snap-in retention capability for engagement with a dental implant or implant analog having a first engagement section. The coping includes a second engagement section that is configured for a snap-in or frictional fit with the first engagement section to releasably secure the coping to the implant. In example embodiments, the coping can also be secured to the dental implant with a threaded fastener.

In one aspect, the invention relates to a coping for retention with a dental implant. The implant includes a first engagement section. The coping includes an elongate body extending from a first end to a second end. The elongate body includes a first end portion including a scan feature, a medial portion positioned adjacent the first end portion and having a generally uniform cylindrical portion, a second end portion positioned adjacent the medial portion including a second engagement section having at least one engagement rib, and an end post for axial alignment within an internal threaded portion of the implant.

In example embodiments, the second engagement section includes a male hex (i.e., hexagonal) profile, the first engagement section includes a female hex profile, and the male and female hex profiles are configured for cooperative interengagement therebetween.

In example embodiments, the at least one engagement rib of the male hex profile is sized at least slightly larger than the size of the female hex profile such that the male hex is provided with a snap-in frictional fit with the female hex. In example embodiments, the male hex includes at least one engagement rib on at least three of its six surfaces. In example embodiments, at least a portion of the medial section is formed from a titanium alloy or other radiopaque material. In example embodiments, the medial section allows for proper seating verification of the coping within the implant via x-ray imaging. In example embodiments, the elongate body is formed from polyether ether ketone plastic.

In example embodiments, the scan feature of the first end portion includes one or more flats, wherein at least one of the flats are configured to be recognized by an intraoral or table top scanner. In example embodiments, the scan feature includes three flats, wherein two of the three flats are oriented generally parallel to each other, and wherein one of the three flats is oriented generally perpendicular relative to the other two flats. In this embodiment, the parallel flats are configured to help retain the coping in an impression material. The perpendicular flat is configured for recognition by the scanner. In example embodiments, the first end portion includes a retaining feature configured to help hold the coping in an impression material. In example embodiments, the medial portion is color coded by anodizing to match a platform color of the implant. In example embodiments, the second engagement section of the scan body is configured for engagement with both a dental implant and/or with an implant analog.

In another aspect, the invention relates to a coping system comprising a coping for removable engagement with an implant, the implant including a first engagement section. In example embodiments, the coping includes an elongate body extending from a first end to a second end, a first end portion positioned at the first end and having a scan feature including one or more flats, a medial portion positioned adjacent the first end portion, a second end portion positioned adjacent the medial portion having a second engagement section having at least one engagement rib for frictionally engaging the first engagement section, and a channel extending through the elongate body from the first end portion to the second end portion. The coping system also includes at least one insert configured to be inserted through the channel to engage the dental implant.

In example embodiments, the first engagement section includes a female hex, the second engagement section includes a male hex, and the male and female hex are configured for interengagement therebetween. In example embodiments, at least one engagement rib is provided on a surface of the male hex. In example embodiments, the male hex includes at least one engagement rib on at least three surfaces.

In example embodiments, the at least one insert comprises a removable pin and wherein a portion of the removable pin extends below the second end portion of the elongate body for axial alignment within an internal threaded portion of the implant. In example embodiments, the at least one insert comprises an abutment screw configured to engage an internal threaded portion of the implant. In example embodiments, the at least one insert comprises an impression post configured at a first end to engage an internal threaded portion of the implant and at a second end engage a dental impression material.

In still another aspect, the invention relates to a method of fastening a coping to an implant. The method includes providing an implant, the implant having a first engagement section; providing a coping, the coping having a second engagement section, a channel extending through the coping, and a removable pin inserted into the coping such that a portion of the removable pin extends beyond the bottom of the male engagement body. The method further comprises the second engagement section being generally complementary in shape to the first engagement section; providing at least one engagement feature on at least a portion of the second engagement section, the at least one engagement feature generally protruding outwardly from the second engagement section; engaging the second engagement section of the coping with the first engagement section of the implant such that the at least one engagement feature of the second engagement section frictionally engages at least a portion of the first engagement section. In example embodiments, the at least one engagement feature of the second engagement section is in the form of a rib.

In example embodiments, the method can further comprise removing the removable pin from the channel and inserting a threaded fastener through the channel to engage an internal threaded portion of the implant. The threaded fastener is configured to hold the coping in engagement with the implant.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description are exemplary and explanatory of example embodiments of the invention, and are not restrictive of the invention, as claimed.

### BRIEF DESCRIPTION OF THE DRAWINGS

FIG. 1 is a perspective view of a dental coping according to an example embodiment of the present invention.

FIG. 2 is a side view of the coping of FIG. 1.

FIG. 3 is a top view of the coping of FIG. 1.

FIG. 4 is a perspective view of the coping of FIG. 1 being inserted into a dental implant.

FIG. 5A is a detailed perspective view of a second end portion of the coping of FIG. 1.

FIG. 5B is an end view of the second end portion of the coping of FIG. 5A.

FIG. 6 is a perspective view of the implant of FIG. 4.

FIG. 7 is a cross-sectional view of the coping with the implant of FIG. 6, showing a snap-in feature of the coping removably engaging an engagement feature of the implant.

FIG. 8 is a detailed cross-sectional view of FIG. 7 showing the snap-in feature of the coping removably engaging an engagement feature of the implant.

FIG. 9 is a perspective view of a dental coping system according to another example embodiment of the present invention.

FIG. 10 is a cross-sectional perspective view of the coping system of FIG. 9.

FIG. 11 is a detailed cross-sectional view of the upper end portion of the coping system of FIG. 10.

FIG. 12 shows an impression post for use the coping system of FIG. 9.

FIG. 13 is an exploded view of the coping system of FIG. 9.

FIG. 14 shows the impression post of FIG. 12 in use with the coping of FIG. 9.

FIG. 15 shows an abutment screw for use the coping system of FIG. 9.

FIG. 16 shows the abutment screw of FIG. 15 in use with the coping of FIG. 9.

### DETAILED DESCRIPTION OF EXAMPLE EMBODIMENTS

The present invention may be understood more readily by reference to the following detailed description taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

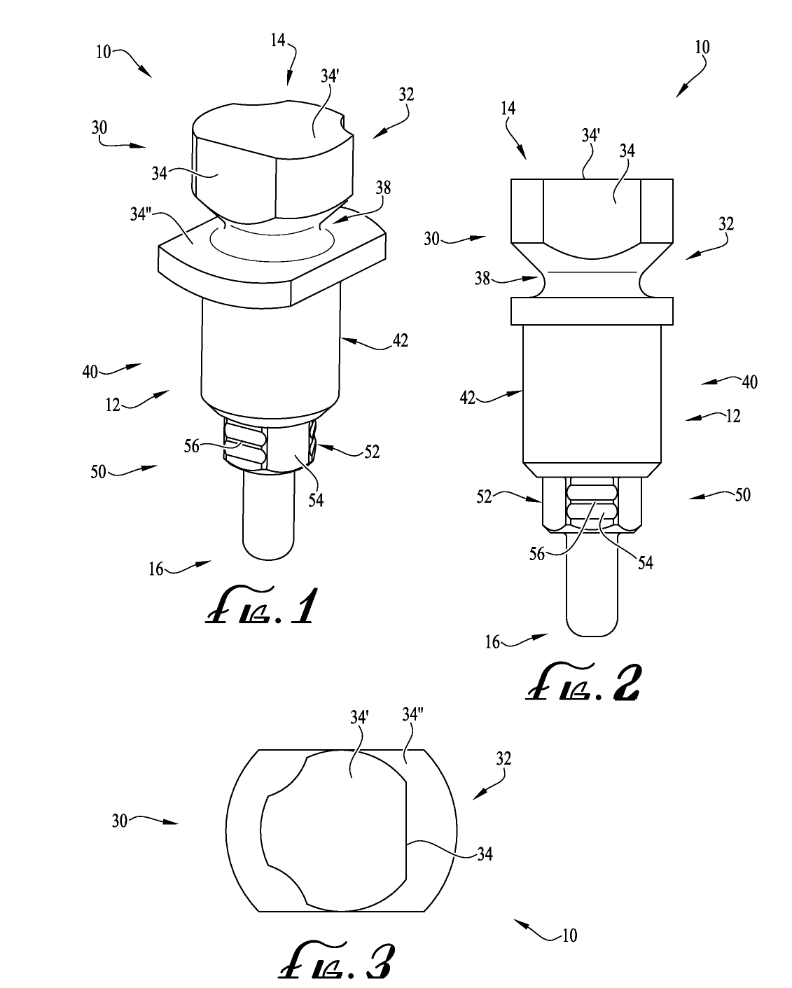

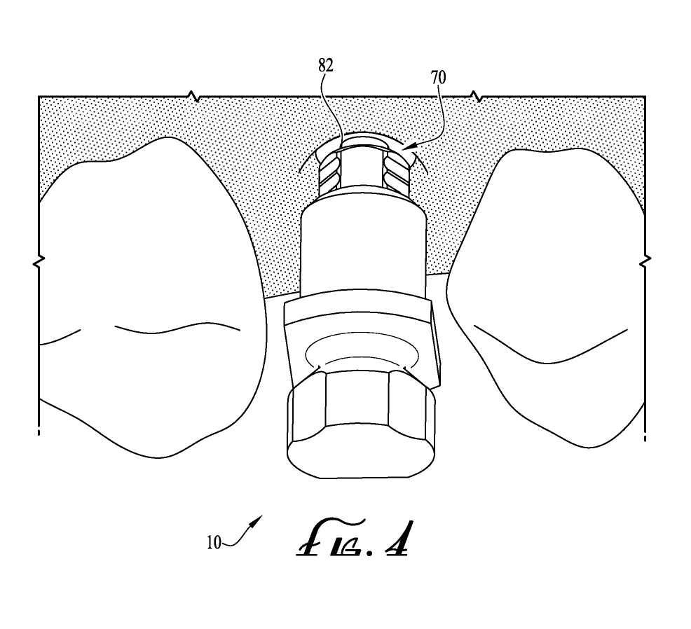

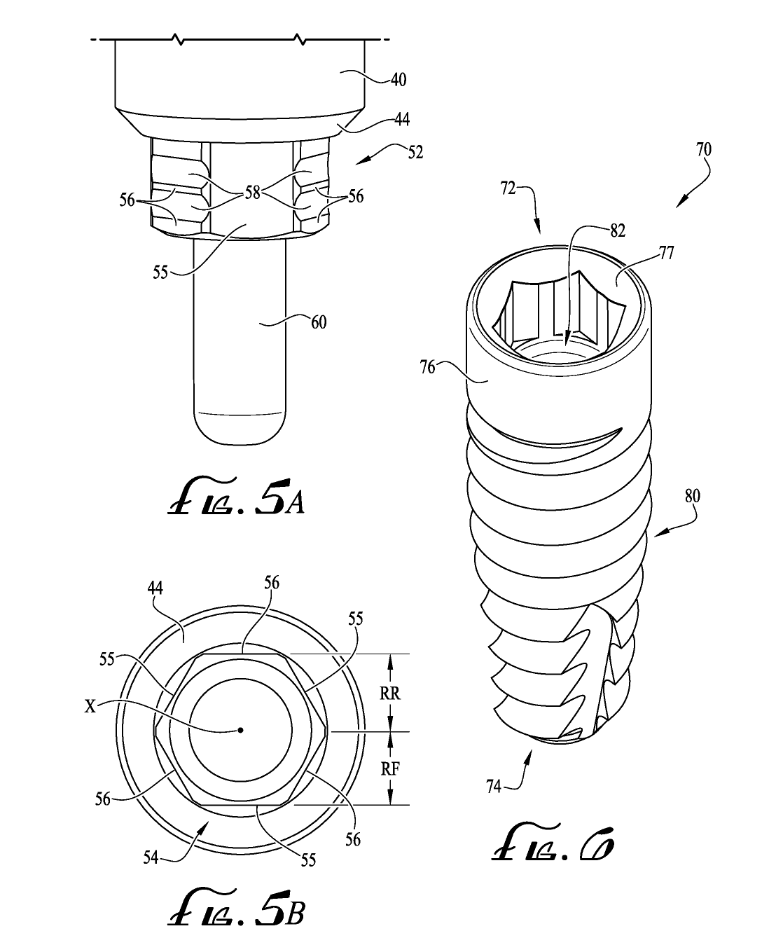

With reference now to the drawing figures, wherein like reference numbers represent corresponding parts throughout the several views, FIGS. 1-8 show a dental coping 10 for use with a dental implant 70 according to an example embodiment of the present invention. In example embodiments, the coping 10 enables a dental clinician to scan a patient's mouth with dental imaging equipment (e.g., intraoral scanner) to provide a digital dental restorative pathway, for example, so that a prosthesis can be fabricated to engage with the implant 70 that is engaged with the patient's jaw. The coping 10 is also designed for use in dental impression techniques such as closed tray and triple tray impressions. In example embodiments, the coping 10 is configured such that no separate fasteners, screws, etc. are required for mounting the coping assembly 10 to the implant 70. In example embodiments, the coping 10 engages with a first engagement section 82 of the implant 70, as shown in FIG. 4.

As depicted in FIGS. 1-3, the coping 10 generally comprises an elongate body 12 having a first end 14 and a second end 16 generally opposite thereto. In example embodiments, the elongate body 12 generally includes a first end section 30, a medial section 40, and a lower end section 50. The first end section 30 is configured to engage with a digital scanner for creating a three-dimensional model. The lower end section 50 is configured to engage with the dental implant 70. According to one example embodiment, the elongate body 12 is formed from a material suitable for dental applications for example polyether ether ketone plastic (PEEK). In alternate example embodiments, the elongate body 12 can be formed from a radiopaque plastic (e.g., PEEK with barium sulfate), or can optionally be formed from other plastics or metals. In example embodiments, the elongate body 12 is integrally formed as one unitary piece. Alternatively, one or more portions of the elongate body 12 may be formed separately and connected together.

As depicted in FIGS. 1-3, the first end portion 30 of the coping 10 generally comprises a scan feature 32 including one or more flats 34, 34′, 34″. In example embodiments, the scan feature 32 comprises three flats 34, 34′, 34″, for example, whereby two of the flats 34′, 34″ are generally oriented parallel to each other and the other flat 34 is generally oriented perpendicular relative to the other two flats 34′, 34″. Preferably, the flats 34, 34′, 34″ are capable of being scanned and recognized by an intraoral or tabletop scanner, which allows for the creation of a digital restorative pathway (e.g., 3-dimensional model) of the patient's dental area. In example embodiments, the perpendicular flat 34 is configured to assist the intraoral or tabletop scanner in orienting the scan body. The parallel flats 34′, 34″ are configured to help retain the coping in a pick-up impression material. In other embodiments, different configurations of scan features can be used. In the depicted embodiment, the first end portion 30 includes a polygonal shaped protrusion 36 extending upward from a substantially flat flange 34″″. The protrusion 36 includes a substantially flat top 34′ and at least one flat side 34 to form two of the flats of the scan feature 32. The flange 34″ can form a third flat of the scan feature 32. In example embodiments, portions of the protrusion 36 are curved or otherwise configured to form a gripping surface when inserting or removing the coping 10 from the dental implant 70. In other embodiments, a differently shaped scan feature with a different number of flats can be used. In example embodiments, the first end portion 30 of the coping 10 includes at least one retaining or mechanical retention feature 38 configured to help encapsulate and retain the coping in an impression material. In the depicted embodiment, the transition 38 between the protrusion 36 and the flange 34″ includes and undercut wherein the transition is a smaller diameter than the protrusion. The undercut transition 38 is configured to assist in retention within an impression material during a “pick-up” dental impression technique (discussed further below). In alternative embodiments, other retaining features including flanges, hooks, and surface treatments can be used. In other embodiments, the mechanical retention feature can be positioned on the medial portion 40 of the coping 10 as discussed below.

In example embodiments one or more portions of the scan feature(s) and/or other portions of the coping assembly comprise an x-ray imagable material or material(s) compatible with alternative clinical imaging systems and procedures, sufficient to specify position and orientation of the coping in engagement with the implant. For example, one or more of the flats 34, 34′, 34″ can be formed from a radiopaque material, or for example, can be at least partially dipped or coated in a radiopaque material. In example embodiments, the elongate body 12 is entirely formed from a PEEK material, which is blended with barium sulfate prior to molding the body 12, or for example, wherein barium sulfate is applied to an outer surface of one or more portions of the body 12.

The medial portion 40 is generally positioned adjacent to the first end portion 30 and comprises a generally uniform cylindrical portion 42. In example embodiments, the medial portion 40 is formed, entirely or partially, from a metallic material to allow for X-ray seating verification, for example, so that the clinician can ensure that the coping 10 is properly seated and fitted within the implant 70 during the scanning procedure. In example embodiments, the medial section 40 can be surrounded by a sleeve formed from a metallic material. In alternate embodiments, medial portion 40 can be formed from other materials, for example, a metal such as stainless steel or cobalt-chromium (CoCr), or a radiopaque plastic material. In example embodiments, the medial portion 40 is optionally provided in one of a plurality of colors (e.g., which are generally anodized) so that the coping 10 is color coded whereby the clinician can easily identify the assembly 10 and place the assembly 10 in the appropriate implant (e.g., having same color as the medial portion 40). For example, the implant (or portions thereof) may also be colored to correspond to the coping 10. Thus, during procedures where more than coping is required (e.g., multiple implants each requiring a prosthesis), each of the copings 10 will be colored differently to correspond to the correct implant. According to example embodiments, the medial portion 40 can be anodized or otherwise treated or colored to apply a desired color thereto, for example, to match the color of the implant prosthetic platform color. In other embodiments, the medial portion 40 can comprise a first medial portion adjacent to the first end section and a second medial portion adjacent the second end section. The first medial portion can comprise a mechanical retention feature. The second medial portion can comprise a generally uniform cylindrical portion.

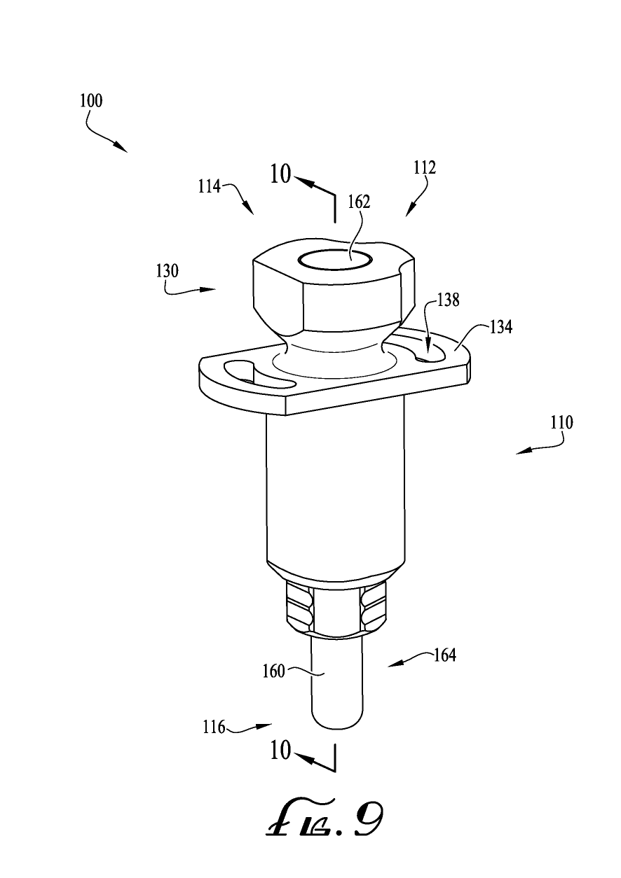

The second end portion 50 is generally adjacent to the medial portion 40. The second end portion 50 includes a second engagement section 52 that is preferably complementary in shape to the first engagement section 82 of the implant 70. The second engagement section 52 can be a male polygonal body (such as a hexagonal protrusion). The first engagement section 82 of the implant 70 can be a female polygonal (for example hexagonal) plug, for example, so that the male polygonal body is capable of cooperative engagement with the female polygonal plug. In example embodiments, the configuration of the male body and female plug may be commonly known as external (plug) and internal (socket) rotational hex drive profiles. In other example embodiments, other configurations of engagement sections (including non-polygonal surfaces) may be employed. For example, according to example embodiments, the second engagement section 52 can be configured and adapted for cooperative engagement with other known implant systems (e.g., Nobel Biocare® NobelReplace™, Straumann®, etc.). The profile and configuration of the first and second engagement surfaces 82, 52 preferably retain the coping 10 in the implant 70 and prevent rotation of the coping relative to the implant. The profile and configuration of the second engagement section 52 optionally matches or corresponds at least in part to the profile and configuration of a dental implant abutment mount to which a dental prosthesis is mounted for compatibility with the implant. Furthermore, an end post 60 extends from adjacent the second engagement section 52 to the second end 16 of the coping 10. According to example embodiments, the end post 60 is configured to maintain axial alignment of the coping assembly 10 with the implant 70, for example, wherein the end post 60 is generally sized to fit within an internal threaded portion 84 of the implant 70 (see FIGS. 7-8).

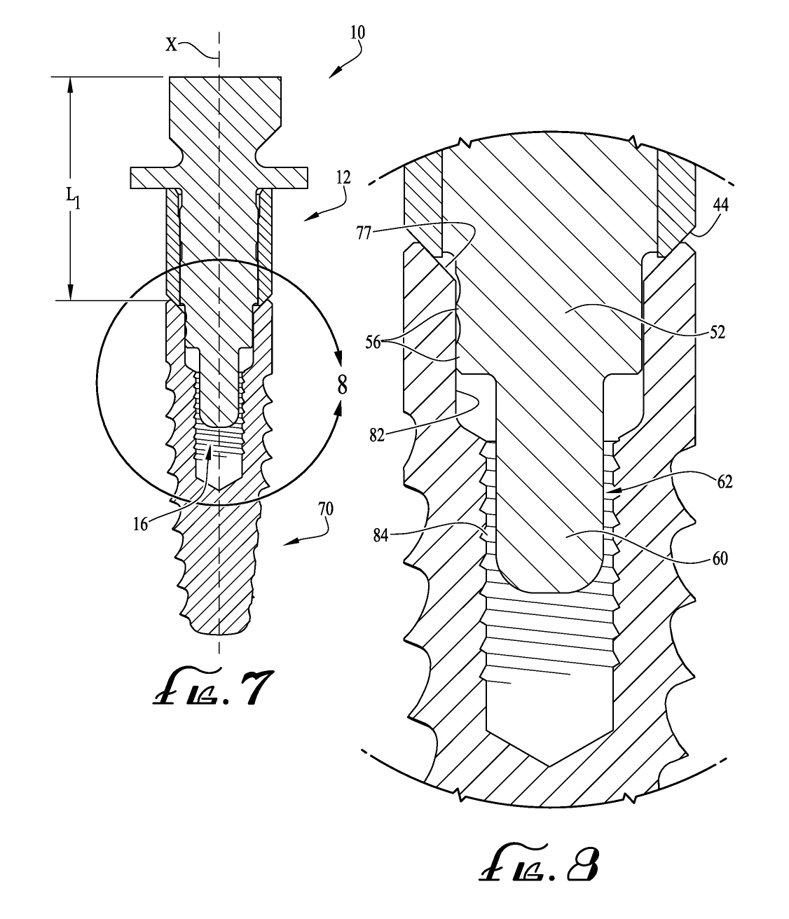

As depicted in FIG. 5A, the male body or plug 52 of the second engagement section of the coping 10 preferably comprises one or more surface features formed thereon for frictionally or otherwise releasably and positively engaging the first engagement section 82 of the dental implant 70. Generally, the male plug 52 includes a plurality of engagement surfaces 54. In the depicted embodiment, at least one of the surfaces 54 of the male plug 52 comprises one or more snap-in releasable engagement features or engagement ribs 56. In example embodiments, the engagement ribs 56 generally extend horizontally along at least one of the surfaces 54, and a groove 58 or flat generally extends along one or more sides of the engagement ribs 56. In example embodiments, the engagement ribs 56 are dimensioned to be at least slightly larger than a majority of the surface 54 it is formed on for providing a frictional engagement fit with the first engagement section 82. For example, where the first engagement section 82 is a female hexagonal (“hex”) configuration and the second engagement section 52 is a male hex configuration, the engagement ribs 56 extend or project outwardly at least partially beyond the dimension of the female hex of the first engagement section 82, for example, so that there is at least a slight amount of interference between the first and second engagement sections to provide for a releasable or detachable friction fit therebetween.

According to example embodiments and as depicted in FIG. 5B, at least three of the six transverse side surfaces 54 of the male hex 52 of the second engagement section 50 comprise one or more engagement ribs 56, which generally extend horizontally or transversely relative to the longitudinal axis X of the elongate body 12. The side surfaces 54 that are not provided with one or more engagement ribs 56 define a smooth and planar surface 55. In example embodiments, every other surface of the male hex comprises one or more of the engagement ribs 56, for example, such that the ribs 56 are generally equally spaced apart around the male hex and whereby engagement with the first engagement section 82 causes the coping 10 to become axially and concentrically aligned with the implant 70. Thus, in example embodiments, three of the surfaces 54 comprise one or more engagement ribs 56, and the other three surfaces can define generally smooth and planar surfaces 55 (see FIGS. 5A-B).

According to example embodiments, the surfaces 54 comprising the engagement ribs 56 define a dimension RR between an outer surface of the rib 56 and an axis X extending axially therethrough, and the smooth finished surface 55 has a dimension of RF that is defined between an outer surface of the finished surface 55 and the X axis shown in FIG. 5B. In example embodiments, the dimension RR is between about 0.25%-8% greater than the dimension RF, more preferably between about 0.25%-4%, for example, about 2% according to an example embodiment of the present invention. According to one example embodiment, the dimension RR is about 0.0473 inches and the dimension RF is about 0.0482 inches. Optionally, the dimensional differences between dimension RR and RF can be chosen as desired, for example, to provide for a releasable frictional engagement fit. In example embodiments, the frictional engagement provided between the ribs 56 and the implant 70 are such that a force of between about 0.4-8 lbf is required to cause disengagement between the first and second engagement sections. Alternatively, the elements may be configured for engagement and disengagement with less or greater force.

Optionally, the one or more engagement ribs 56 may take other forms (e.g., tabs, clips, indents, detents, etc.) and be positioned as desired on one or more surfaces 54 of the male hex 52. Optionally, the engagement feature(s) can comprise a compressible, deformable, spring-biased, or otherwise resilient body or member for positively and removably engaging the implant 70. In further example embodiments, the engagement feature(s) comprise one or more snap-fit couplings. In example embodiments, the female hex of the first engagement section 82 is generally standard without any additional surface or engagement features for providing engagement with the engagement ribs 56. Alternatively, one or more surface features may be formed along one or more surfaces of the female hex of the first engagement section 82 to provide additional interengagement with the engagement ribs 56 if the second engagement section 52. Further optionally, the one or more engagement ribs 56 may be generally merged together to form a surface such that a substantially larger surface area can be provided with an interference fit with the first engagement section 82 of the female hex. In other embodiments, for example for small sizes of copings, or in other circumstances as well, the ribs on the male irregular plug can be eliminated. Thus, optionally the male irregular hexagonal body can in another example comprise six external contact surfaces, and all of the contact surfaces can be substantially flat without ribs. Referring back to FIG. 1, according to example embodiments of the present invention, at least one of the flats 34, 34′, 34″ of the scan feature 32 is oriented to be parallel with one of the surfaces 54 of the engagement section 52. According to one example embodiment, the generally vertical flat 34 of the scan feature 32 is oriented to be parallel with respect to one of the surfaces 54 of the engagement section 52, for example, such that the scan feature 32 can be properly oriented when removably engaged with the first engagement section of the implant 70 or the implant analog.

In example embodiments, the coping 10 is used with a dental implant 70 as shown in FIG. 6. Thus, with the implant 70 secured within the bone structure of the patient's jaw, the coping 70 is releasably engaged by a frictional fit or snap coupling with the implant 70, and the intra oral scanning or impression can be performed. According to other example embodiments, the coping 10 can be used with an implant analog (e.g., model of the patient's dentition formed by an impression), for example, wherein the coping 10 can be frictionally engaged with the implant analog. As such, the coping 10 as described herein may be provided for use with an implant when using an intraoral scanner, using an impression technique, or alternatively may be provided for engagement with an implant analog. Accordingly, the coping 10 provides for multiple functionality described in further detail below.

As shown in FIG. 6, the implant 70 overall is generally cylindrical in shape and extends from a first end 72 to a second end 74. The first end 72 includes a peripheral surface 76 and the second end 74 comprises threads 80. Generally, the threads 80 extend from the second end 74 to a portion of the peripheral surface 76. The first end 72 defines a generally centrally-positioned orifice that comprises an engagement body, socket or other surfaces or features forming a first engagement section 82, such as a female receiver or socket for a hexagonal driver, and an internal threaded portion 84 (see FIGS. 7-8). Preferably, the first engagement section 82 is provided for receiving and releasably engaging a receiver, plug or other surfaces or features forming a second engagement section 52 of the coping 10 (as will be described below). Optionally, one or more self-tapping flutes can be formed on the implant 20 near the second end 74.

FIGS. 7-8 show the coping 10 removably or releasably engaged with the implant 70, for example, wherein the second engagement section 52 is frictionally engaged (e.g., snap-in fit retention) with the first engagement section 82. As shown in FIG. 8, the engagement ribs 56 are frictionally engaged with a surface of the first engagement section 82. Preferably, as mentioned above, the end post 60 (and coping 10 thereof) is substantially axially aligned with the internal threaded portion 84 of the implant 70 and the medial portion 40 is fully seated with the first end 72 of the implant 70, thereby providing axial alignment along an axis X of the coping 10 (having a second elongate axis) with the implant 70 (having a first elongate axis). Similarly, when using an analog, the equal distribution of the engagement ribs 56 around the surfaces of the second engagement section 52 preferably provide for axial alignment of the coping 10 with an elongate axis of the analog. In example embodiments, the post 60 is generally sized and shaped to be at least partially smaller than a diameter defined by the inward-most edge of the internal threaded portion 84, for example, such that an outer periphery portion 62 of the post 60 is generally inwardly offset from the internal threaded portion 84 (see FIG. 8). Preferably, the post 60 provides for precise location during scanning, for example, as the post 60 preferably provides for axially aligning the implant 70 with the coping. In alternate embodiments, the post 60 can be configured to engage at least a portion of the internal threaded portion 84 during coupling engagement of the first and second engagement sections, which may further provide for assistance in maintaining proper alignment of the coping with the internal threaded portion of the implant 70.

In example embodiments, a chamfered surface or bevel 44 is formed along an end portion of the medial portion 40 to assist in fully seating with a chamfered surface 77 of the implant 70 when the coping 10 is fitted within the first engagement section 82 of the implant 70. According to example embodiments, the mating or interface geometry defined between the bevel 44 and the chamfered surface 77 represents a beveled connection. As depicted in FIG. 8, the bevel connection is configured such that about a half of the surface area of the bevel 44 is engaged with about a half of the surface area of the chamfered surface 77. In alternate example embodiments, more or less than about half of the surface areas of the bevel and chamfered surface can be configured to engage when the coping 10 is fully seated with the implant 70. In example embodiments, with the bevel 44 fully seated and engaged with the chamfered surface 77, x-ray imaging can identify the engagement between the medial portion and the chamfered surface, for example, to verify that the coping 10 is fully seated and engaged with the implant, or for example, with an implant analog.

Alternatively, the mating or interface geometry between the medial portion 40 and the implant 70 can be in the form of a square or butt joint (e.g., engagement of flat/parallel surfaces of the medial portion and implant without a bevel or chamfer), or can be configured otherwise such that seating verification is obtainable. For example, the medial portion 40 and/or the second engagement section 52 can be configured and adapted for mating engagement with other known implant systems (e.g., Nobel Biocare® NobelReplace™, Straumann®, Zimmer Biomet or Zimmer dba Zimmer Dental, Biomet 3I, Dentsply, Astra, Implant Direct, CAMLOG®, etc.).

As depicted in FIG. 7, the elongate body 12 extends along a longitudinal axis X and defines a length L1 between the first and second ends 14 of the coping and the top of the implant 70 when the coping 10 is engaged with the implant. In example embodiments, the length L1 is between about 1-15 mm, more preferably between about 0.3-1 inches, and still more preferably between about 5-11 mm, for example, between about 7-9 mm.

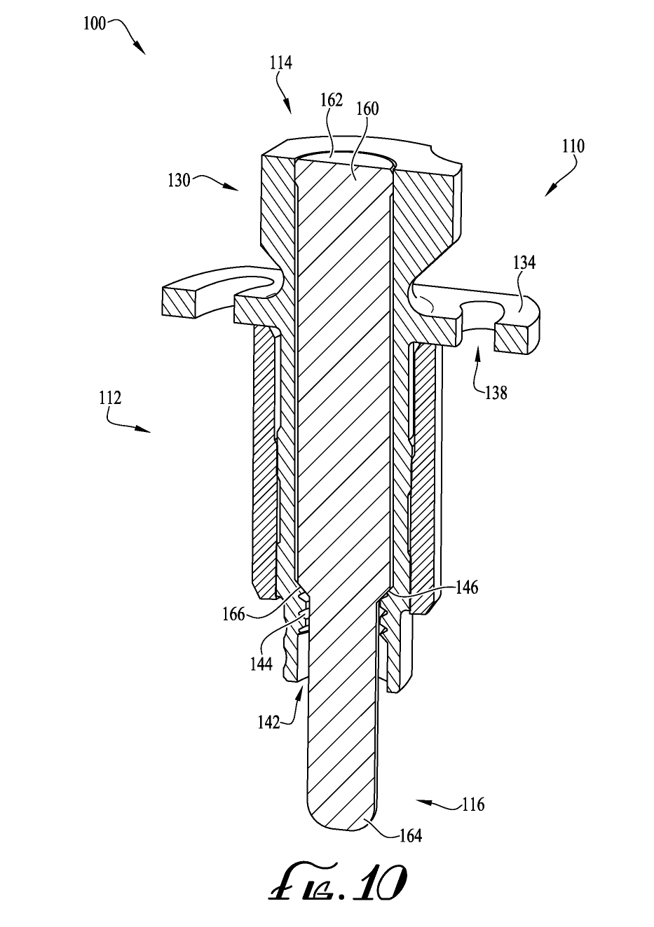

FIG. 9-14 show a dental coping system 100 for use with a dental implant 70 according to another example embodiment of the present invention. The coping 110 of the coping system 100 includes an elongate body 112 shaped substantially similar to the coping 10 of the previous embodiment. The coping 110 is configured to be both snap fitted and fastened into a dental implant 70. The coping system 100 includes a plurality of inserts 160, 160′, 160″ for use with the coping 110. The different inserts allow the coping system 100 to be multi-functional such that it can be used in scanning and dental impression techniques requiring the coping 110 to be snap-fitted into the implant 70 but can also be used in dental impression techniques requiring the coping to be fastened to the dental implant.

The coping 110 of the depicted embodiment includes a retaining feature 138 positioned on its flange 134. In the example embodiment, the flange 134 of the first end portion 130 includes at least one opening 138 extending through the flange 134. In the depicted embodiment, the openings 138 are a pair of slots formed in the flange 134 on either side of the protrusion 136. The openings or slots 138 are configured to assist with retention of the coping 110 in “pick-up” dental impressions, such as closed and triple tray impressions, where the coping is retained within the impression material and removed from the implant.

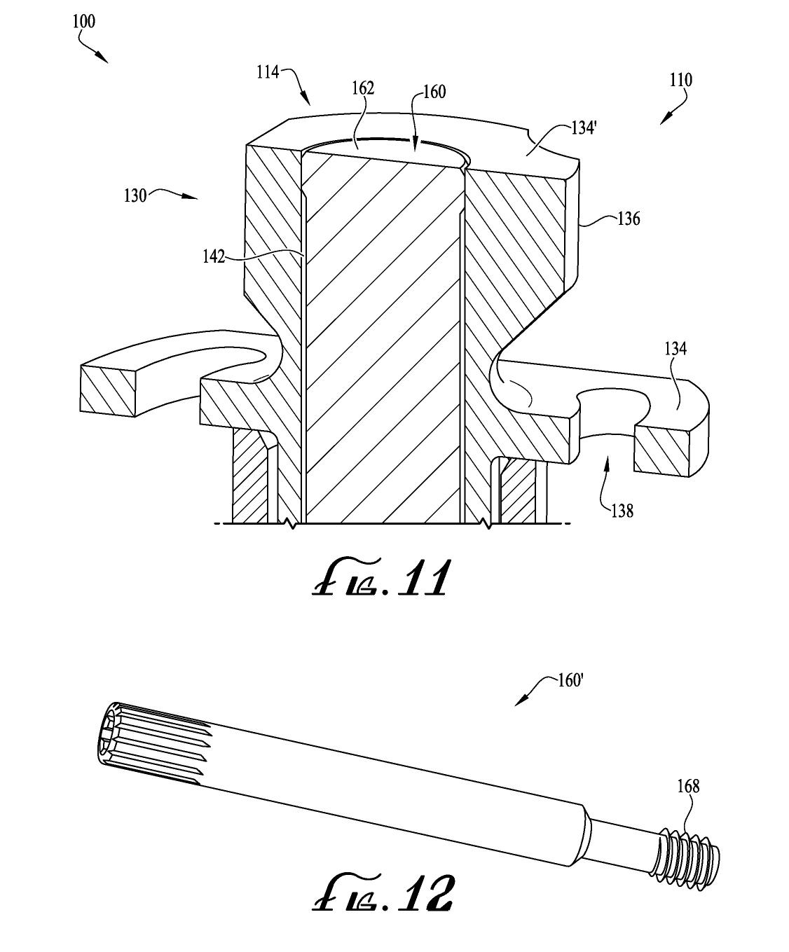

The coping 110 of the depicted embodiment also includes a cylindrical channel 142, shown in FIGS. 10 and 11, extending through the elongate body 112 coping from the first end portion 130 to the second end portion 150 of the coping 110. In example embodiments, the channel 142 is preferably sized such that a dental tool or probe is capable of being inserted at least partially therein. The cylindrical channel 142 generally extends from an opening in the top of the protrusion 136 of the first end portion 130, through the medial portion 140 and through an opening in the bottom of the second end portion 150. Optionally, the cylindrical channel 142 includes threads 144 configured to engage a screw or other threaded fastener. In the depicted embodiment, the threads 144 are positioned adjacent to the second end portion 150 of the coping 110. Alternatively, the threads or threaded portion 144 is positioned elsewhere in the cylindrical channel 142. The cylindrical channel 142 is configured to receive a variety of inserts including pins 160 and threaded screws or fasteners 160′, 160″ depending on the application of the coping 110.

In example embodiments, the coping 110 can include a post or guide pin 160 inserted into the cylindrical channel 142, as shown in FIGS. 9-11. The pin 160 generally has a first, top end 162 and a second, bottom end 164. In the depicted embodiment, the bottom end 164 of the pin is configured to extend beyond the second end portion 150 of the coping 110 when inserted into the channel 142. The bottom end 164 of the pin 160 is positioned to function similarly to the end post 60 of the coping 10 of the previous embodiment. In the depicted embodiment, the top end 162 of the pin 160 is generally flat and is flush with the top flat surface 134′ of the protrusion 136 of the first end portion 130. In other embodiments, the top 162 of the pin 160 can sit within or extend beyond the top of the channel 142. In example embodiments, the top 162 of the pin can extend above the top flat surface 134′ of the coping 110 and can include a series of flat surfaces configured to engage a digital scanner. Thus, this extended pin can be used when the digital scanner requires a scan surface that is higher than the top of the coping.

The pin 160 generally includes a stop surface 166 configured to engage a corresponding stop surface 146 in the channel 142 to control the position of the pin within the channel. In the depicted embodiment, the pin stop surface 166 is a beveled portion formed on the outer periphery of the pin 160. The channel 142 includes a corresponding beveled stop surface 146 configured to engage the beveled surface 166 of the pin 160. In the depicted embodiment, the channel stop surface 146 is positioned adjacent to the second end portion 150 of the coping 110. In other embodiments, the channel stop surface 146 can be positioned at another point within the channel 142. The stop surfaces are configured such that when the pin stop surface 166 is seated on the channel stop surface 144 it is in the proper position within the channel 142. In alternate embodiments, other configurations of stop surfaces can be used. In the depicted embodiment, the pin 160 has a generally smooth outer surface such that the pin can be push fitted into, and pulled out of, the channel 142 of the coping 110. In other embodiments, the pin 160 can include threads or another fastening mechanism configured to help hold the pin within the channel 140. Example fastening mechanisms include magnets, snap fasteners, or other fastening devices configured to removably hold the pin 160 within the cylinder 142.

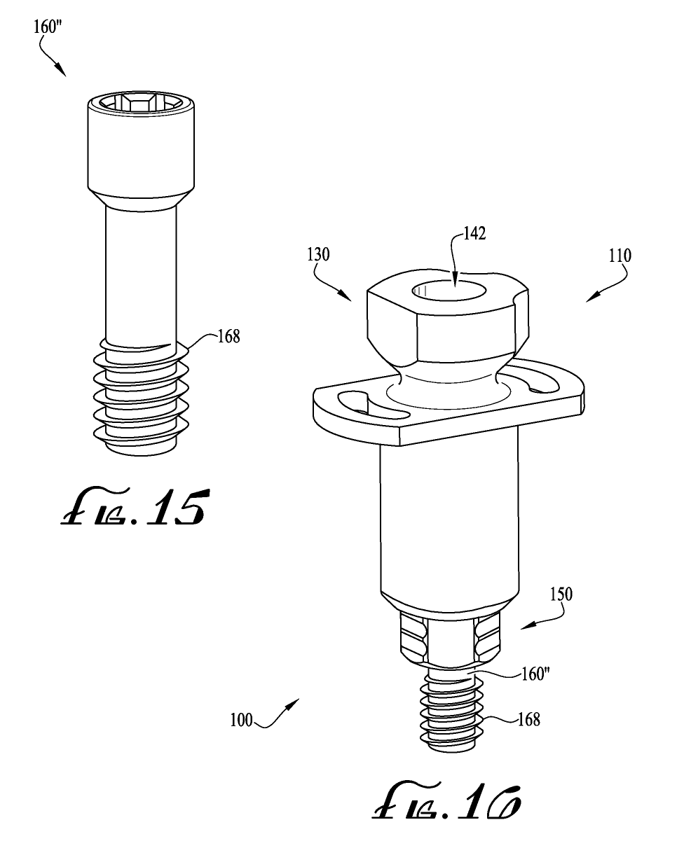

The coping system 100 can include a variety of other inserts 160′, 160″ configured to engage with the channel 142 of the coping 110. Example inserts include threaded fasteners 160′, 160″. Example threaded fasteners are shaped similar to the above discussed pin 160 but include a threaded portion 168 positioned at the bottom end 164′ of the fastener. The threaded portion 168 is configured to engage the internal threaded portion 84 of the implant 70 to hold the coping 110 in engagement with the implant. The fasteners 160′, 160″ can be a variety of heights including those where the top of the fastener 160′ extends beyond the top of the coping 110 as shown in FIGS. 12 and 14, and others where the top of the fastener 160″ is within the channel 142 of the coping, as shown in FIGS. 15 and 16. Examples of threaded inserts include abutment screws 160″ and impression post 160′ used, for example, in open tray impressions (discussed further below).

In use, the coping 110 is generally provided for fitting within the patient's mouth in removable engagement within an installed implant 70 before either taking a digital scan or physical impression of the patient's mouth. In some example embodiments, the clinician places the second engagement section 152 (e.g., male hex) of the coping 110 within the first engagement section 82 (e.g., female hex) of the implant 70 by grasping the coping with their fingers or with a tool and firmly seating the first and second engagement sections together. Depending on the tolerance of the fit and/or the interference caused by the engagement ribs of the second engagement section 152, more or less force may be required to fully seat the second engagement section with the first engagement section 82. In example embodiments, the frictional engagement provided between the ribs 56 and the implant 70 (e.g., first and second engagement sections) is such that a force of between about 0.40-8.01 lbf may be applied to engage and disengage the first and second engagement sections. Alternatively, the components may be configured for a greater or lesser engagement and/or disengagement force. In example embodiments, a light to moderate hand pressure is sufficient. Once the coping 110 is frictionally fitted into the implant it can be used as a scan body or a coping in pick-up impression techniques. The coping 110 of the example embodiment can also be fastened to the implant for use is impression techniques where the coping remains attached to the implant.

In example embodiments, the invention relates to a method of using the coping system 100 to create a digital scan of the patient's detention. The method comprises engaging the coping 110 with a dental implant 70 already embedded in the jaw of a patient. The coping can be place and removed from the implant without the need for fasteners. In a clinical setting it can be difficult to manually screwing an abutment screw within the implant to fasten the coping to the implant because some installation drivers can be long, requiring a significant amount of vertical space, thereby making placement of the abutment screw difficult in the posterior of a patient's mouth where vertical space is often limited. To use the coping system 100 as a scan body, the coping 110 with the removable pin 160 inserted into the channel 142 is snap fitted into the insert as described above. Once the coping 110 (or copings if multiple prosthesis are needed) is placed, an intraoral scanner is used to scan the coping, side, and neighboring dentition for a comprehensive digital scan. The intraoral scanner uses the flat surfaces of the coping to align the coping and create a digital implant position that will replicate the actual implant position.

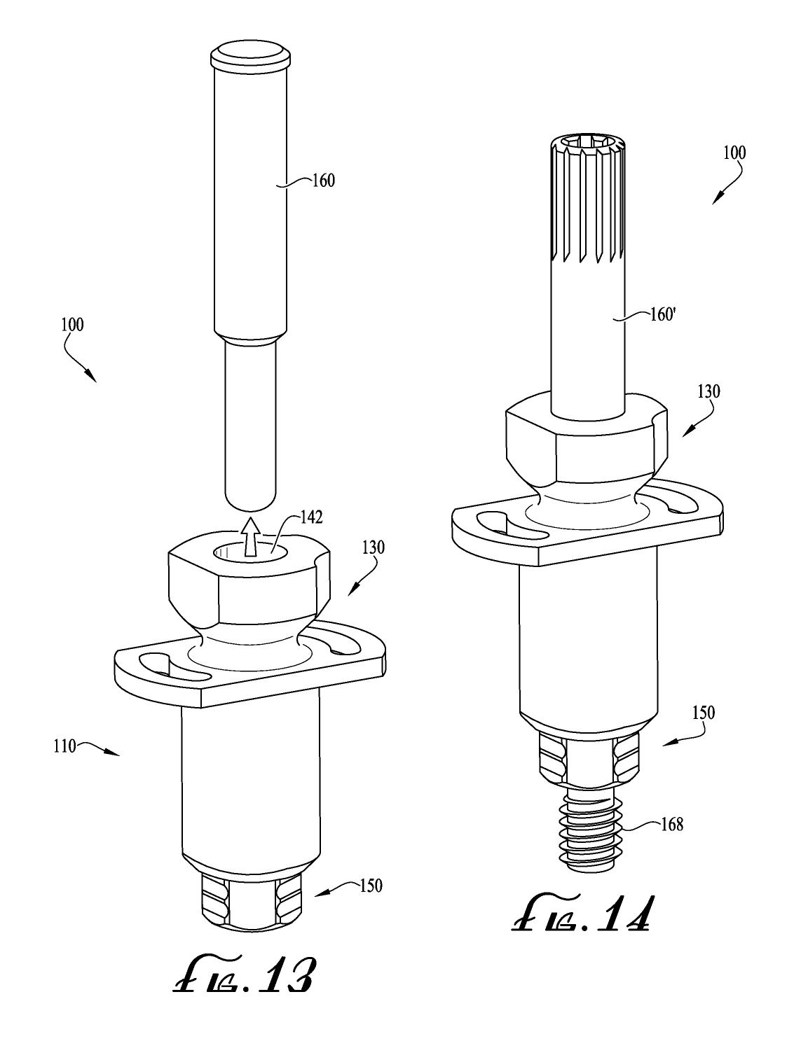

In other embodiments, it may be advantageous to fasten the coping to the dental implant, for example when taking a digital can in a laboratory setting. Often it is advantageous to attach the coping 110 to the implant analog in a laboratory setting to prevent movement of the coping and wear of the friction fit. The coping system 100 of the present invention provides a coping 110 that can also be fastened to the implant or implant analog using a threaded fastener, for example and abutment screw. When a clinician wants to fasten the coping 110 to the implant 70 the pin 160 is removed from the channel 142 of the coping 110, as shown in FIG. 13. Then a threaded fastener or abutment screw 160″ is inserted through the channel 142 to engage the implant 70 and hold the coping 110 in engagement with the implant.

In other embodiments, the present invention relates to a method of using the coping system 100 to create an impression of a patient's dentition where the coping 110 is either retained in the impression or remains attached to the dental implant. For example, in a closed tray pick-up impression the coping 110 is engaged with the implant 70 without the use of an abutment screw or other fastener. The method further comprises depositing medium or heavy body impression material around and over the coping 110, loading an impression tray with impression material and placing the tray over the dentition to create an intraoral impression. Once the impression material has set, the impression tray is remove which now contains and encapsulates the coping. The same method of use can be used in other impression methods that “pick up” and retain the coping 110, such as triple tray impressions.

The same coping system 100 can be used in impression methods that require the coping to be fastened to the dental implant such as an open tray impression. To change the coping 110 from one suitable for use in a closed tray to one suitable for use in an open tray impression the guide pin 160 is removed from the channel 142 of the coping, as shown in FIG. 13. An impression post 160′ is inserted through the channel 142 of the coping and fastened to the implant 70 such that the coping and impression post remain attached to the implant as the impression material sets. The clinician can then remove the guide post from the implant. Thus, the coping system 110 of the present invention can be used in at least four different procedures including a digital scanning in both a clinical and laboratory setting and both “pick-up” and retained impression techniques.

While the invention has been described with reference to example embodiments, it will be understood by those skilled in the art that a variety of modifications, additions and deletions are within the scope of the invention, as defined by the following claims.

What is claimed is:

1. A coping for engagement with a dental implant, the dental implant comprising a first engagement section, the coping comprising:
an elongate body extending from a first end to a second end and defining a second elongate axis, the elongate body comprising:
a first end portion comprising a scan feature;
a medial portion positioned adjacent the first end portion and comprising a generally uniform cylindrical portion;
a second end portion positioned adjacent the medial portion comprising a second engagement comprising at least one engagement rib; and
an end post for axial alignment within an internal threaded portion of the implant.

2. The coping of claim 1, wherein the second engagement section comprises a male hexagonal body, wherein the first engagement section comprises a female hexagonal socket, and wherein the male hexagonal body and the female hexagonal socket are configured for interengagement therebetween.

3. The coping of claim 2, wherein the at least one engagement rib of the male hexagonal body is sized at least slightly larger than the size of the female hexagonal socket such that the male hexagonal body is provided with a snap-in frictional fit with the female hexagonal socket.

4. The coping of claim 2, wherein the male hexagonal body comprises six external contact surfaces, and further comprises at least one engagement rib on each of at least three of the six external contact surfaces.

5. The coping of claim 4, wherein the three contact surfaces comprising the at least one engagement rib are equally distributed around the male hexagonal body.

6. The coping of claim 5, wherein the three contact surfaces comprising the at least one engagement rib increase the precision of the coping and scan feature thereof by axial alignment of the first elongate axis with the second elongate axis.

7. The coping of claim 1, wherein the medial portion is at least partially formed from a titanium alloy or radiopaque material.

8. The coping of claim 1, wherein the elongate body is formed from a polymer.

9. The coping of claim 1, wherein the scan feature of the first end portion comprises one or more flats.

10. The coping of claim 9, wherein the scan feature comprises three flats, wherein two of the three flats are oriented generally parallel to each other, and wherein one of the three flats is oriented generally perpendicular relative to the other two flats.

11. The coping of claim 7, wherein the sleeve is color coded by anodizing to match a platform color of the implant.

12. The coping of claim 1, wherein the second engagement section of the coping is configured for both engagement with an implant and with an implant analog.

13. The coping of claim 1, wherein the first end portion comprises at least one retaining feature configured to hold the coping in an impression material.

14. The coping of claim 13, wherein the at least one retaining feature is at least one slot extending through a portion of the first end portion.

15. A coping system comprising a coping for removable engagement with a dental implant, the implant comprising a receiver, the coping comprising:
an elongate body, comprising a first end portion comprising a scan feature comprising at least one flat, a medial section adjacent to the first end portion, a second end portion positioned adjacent to the medial portion comprising an engagement body configured for cooperative detachable engagement within the receiver of the implant, and a channel extending through the elongate body from the first end portion to the second end portion; and
at least one insert configured to be inserted through the channel to engage the dental implant.

16. The coping system of claim 15, wherein the receiver of the implant comprises a female hex, wherein the engagement body of the coping comprises a male hex, and wherein the male and female hex are configured for interengagement therebetween.

17. The coping system of claim 15, wherein at least one engagement rib is provided on a surface of the engagement body.

18. The coping system of claim 17, wherein the engagement body is hexagonal and comprises six contact surfaces, and wherein at least one engagement rib is provided on each of at least three of the six contact surfaces.

19. The coping system of claim 15, wherein the at least one insert comprises a removable pin and wherein a portion of the removable pin extends below the second end portion of the elongate body for axial alignment within an internal threaded portion of the implant.

20. The coping system of claim 15, wherein the at least one insert comprises an abutment screw configured to engage an internal threaded portion of the implant.

21. The coping system of claim 15, wherein the at least one insert comprises an impression post configured at a first end to engage an internal threaded portion of the implant and at a second end engage a dental impression material.

22. The coping system of claim 21, wherein the sleeve is formed from a titanium alloy or radiopaque material.

23. The coping system of claim 15, wherein the elongate body is formed from polyether ether ketone plastic.

24. The coping system of claim 15, wherein the medial portion is color coded by anodizing to match a platform color of the implant.

25. The coping system of claim 15, wherein the engagement body is configured for removable engagement with both an implant and with an implant analog.

26. A method of fastening a coping to an implant comprising:
providing a dental implant, the dental implant comprising a female socket;
providing a coping, the coping comprising a male engagement body, a channel extending through the coping, and a removable pin inserted into the coping such that a portion of the removable pin extends beyond the bottom of the male engagement body, the male engagement body being generally complementary in shape to the female socket of the implant;
engaging the male engagement body of the coping within the female socket of the implant with a detachable friction fit.

27. The method of claim 26, further comprising removing the removable pin from the channel and inserting a threaded fastener through the channel to engage an internal threaded portion of the implant.
